(19) United States
(12) Patent Application Publication
(10) Pub. No.: US 2025/0044504 A1
(43) Pub. Date: Feb. 6, 2025

(54) CORE/CLADDING STRUCTURED FILAMENT FOR ADDITIVE MANUFACTURE OF MICROSTRUCTURE COMPONENTS

(71) Applicant: Incom, Inc., Charlton, MA (US)

(72) Inventors: Evan Franklin DeBlander, Portland, OR (US); Neil Alexander McIntyre, Vancouver, WA (US); David James Welker, Vancouver, WA (US); Melissa My Quyen Huynh, Vancouver, WA (US); Eric Robert Davidson, Vancouver, WA (US); Michael A. Detarando, Fiskdale, MA (US)

(21) Appl. No.: 18/585,968

(22) Filed: Feb. 23, 2024

Related U.S. Application Data
(60) Provisional application No. 63/530,532, filed on Aug. 3, 2023.

(51) Int. Cl. G02B 6/036; B29C 48/05; B29C 64/118; B29L 11/00; B29L 31/00; B33Y 10/00; B33Y 70/00; G02B 6/02

(52) U.S. Cl. CPC G02B 6/03638; B29C 48/05; B29C 64/118; B33Y 10/00; B33Y 70/00; G02B 6/02042; B29K 2995/0022; B29K 2995/0031; B29L 2011/0075; B29L 2031/731

(57) ABSTRACT

A filament for use as a feedstock in three-dimensional printing of an optical device has a strand-like structure for continuous feeding into a printing nozzle of a three-dimensional printer. The strand-like structure includes one or more of elongated side-by-side core/cladding sections each having an optically transmissive inner core surrounded by a lower-index optically transmissive outer cladding for corresponding light guiding in the optical device. In embodiments, the core may be a solid material or an air core, and in the case of solid material may include scintillation material or other enhancements. Other variations and specifics are disclosed.

### BACKGROUND

The invention is related to the field of additive manufacturing (also known as “three-dimensional printing” or “3D printing”), and in particular to additive manufacturing of microstructure components including optical devices.

### SUMMARY

A filament for use as a feedstock in three-dimensional printing of an optical device has a strand-like structure for continuous feeding into a printing nozzle of a three-dimensional printer. The strand-like structure includes one or more of elongated side-by-side core/cladding sections each having an optically transmissive inner core surrounded by a lower-index optically transmissive outer cladding for corresponding light guiding in the optical device. In embodiments, the core may be a solid material or an air core, and in the case of solid material may include scintillation material or other enhancements. Numerous other variations and specifics are disclosed.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a block diagram of an additive manufacturing system employing a three-dimensional (“3D”) printer to make microstructured components from a core/clad filament;

FIG. 2 is a schematic representation of a cross-section of a core/clad filament;

FIG. 3 is a schematic representation of a multi-layer filament;

FIG. 4 is a schematic representation of drawing a filament from a preform;

FIG. 5 is a flow diagram of a multi-step process for making a core/clad filament;

FIGS. 6A and 6B are depictions of a 3D-printed optical taper and its effect in use;

FIG. 7 is a schematic representation of a 3D-printed bent-fiber component;

FIG. 8 is a representation of another 3D-printed component and its effect in use;

FIG. 9 is a representation of a 3D-printed interleaved fiber bundle;

FIG. 10 is a representation of a known optical faceplate and an aspect of operation; and

FIG. 11 is a representation of a 3D-printed optical faceplate and an aspect of operation.

FIG. 12 is a representation of an optical device having a curve cut into a set of straight optical fibers as conventional formed; and

FIG. 13 is a representation of an optical device with flat and curved surfaces using 3D-printed optical fibers.

### DETAILED DESCRIPTION

### Overview

The disclosure is directed to various aspects of additive manufacturing, also known as “3D printing”, of microstructure components including optical devices. These aspects include filaments for use in such 3D printing, and the manner of making such filaments, as well as example optical devices and methods of making them.

### Embodiments

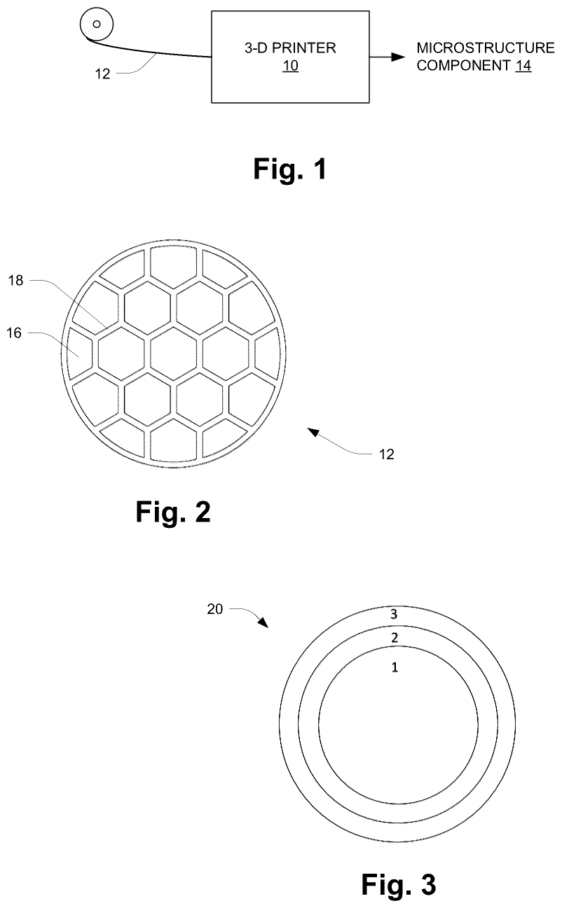

FIG. 1 illustrates an additive manufacturing system having a 3-dimensional (3D) printer 10 that uses a core/clad filament 12 as disclosed herein to produce microstructure components 14. Details of candidate filaments 12, resulting devices or components 14, and customizations of the 3D printer 10 are described below.

### Section I—Filaments and Methods of Making

### 1. Solid Core/Clad Filament

In one example, a filament for use as a feedstock in three-dimensional printing of an optical device has a strand-like structure for continuous feeding into a printing nozzle of a three-dimensional printer. The strand-like structure can include one or more of elongated side-by-side core/cladding sections, each having an optically transmissive inner core surrounded by a lower-index optically transmissive outer cladding for corresponding light guiding in the optical device.

FIG. 2 shows an example of such a multi-strand filament 12 with nineteen core/clad sections, each having a respective core 16 surrounded by a respective cladding 18.

In one embodiment, both core and clad materials consist of thermoplastic resins with melt characteristics (MFI, Tg) similar enough to allow for extrusion through a 3D printing nozzle. Example core materials include PS, PMMA, SMMA, PVDF, Fluoropolymer, PETG, PC, COC, COP, PEN, ABS, ASA, polyester, thermoplastic elastomers, PVA, or other suitable thermoplastics. Example cladding materials include PS, PMMA, SMMA, PVDF, Fluoropolymer, PETG, PC, COC, COP, PEN, ABS, ASA, polyester, thermoplastic elastomers, PVA, or other suitable thermoplastics. The cross-sectional shape of the filament can be adjusted to match possible changes in nozzle shape (circular, triangular, square, hexagonal). In the embodiment of FIG. 2, each core/clad section has a hexagonal cross-sectional shape, while the overall filament 12 has a circular cross-sectional shape.

FIG. 3 illustrates another arrangement in which a single-strand, multi-layer filament 20 has one or more additional concentric cylinders of material (shown as “3”) around an inner core/clad combination (core “1” and clad “2” in this example). Generally, the core 1 may be of a single higher index polymer, or it may include multiple core/clad combinations (e.g., similar to filament 12 of FIG. 2) or other structures as mentioned below. The clad layer 2 consists of a lower index material than core 1. The second layer 3 provides some additional function as needed in a particular application, which can include (1) light absorption (e.g., EMA), to absorb unwanted light and improve optical performance, (2) providing physical/mechanical properties for strength or other purposes including to case the 3D printing process (e.g., lower viscosity at nozzle temperature, increased adhesion) or to case post-processing (e.g., lower viscosity at post-process fusion temperature, reducing Tg below other components in fiber to allow for gluing during fusion). The additional layer 3 may also be used to alter/tune thermal conductivity or electrical conductivity, to reduce wear on the printing nozzle, or to provide etchability.

In the filaments 12 and 20 described above, a core may include a scintillating polymer. Core portions may use a random combination of two or more polymers of different refractive indices to provide Transverse Andersen Localized waveguiding (Nanoguide [NG]). One or more of the random components may be of a scintillating material. These variations are in addition to the possibility of using additional layers such as the layer 3 of FIG. 3 described above. It should also be noted that when a random combination of two or more materials are provided as core, no cladding is necessary to achieve light guiding, and thus a cladding-free structure may be utilized.

A core/clad filament as described above can be used to make devices designed for visible light guiding, such as image transfer in fiber optic faceplates, or for electromagnetic radiation in other regions of the spectrum, such as infrared (IR) or microwave guiding. Acoustic waveguides, such as those designed for ultrasonic waves, could also be made using this filament. If an active scintillating component is used, the filament could be used to produce particle detecting devices.

### 2. Air-Core/Clad Filament

In another arrangement, a filament for use as a feedstock in three-dimensional printing of a capillary device has a strand-like structure for continuous feeding into a printing nozzle of a three-dimensional printer. The strand-like structure includes one or more of elongated side-by-side air/clad sections each having an open air core surrounded by an outer cladding. Example cladding materials include PS, PMMA, SMMA, PVDF, Fluoropolymer, PETG, PC, COC, COP, PEN, ABS, ASA, polyester, thermoplastic elastomers, PVA, or other suitable thermoplastics. The cross-sectional shape of the filament can be adjusted to match possible changes in nozzle shape (circular, triangular, square, hexagonal).

In yet another arrangement, a filament for use as a feedstock in three-dimensional printing of a capillary device has a strand-like structure for continuous feeding into a printing nozzle of a three-dimensional printer, wherein the strand-like structure includes one or more elongated side-by-side core/cladding sections and the core has a sufficiently different chemical solubility from the cladding to allow for its selective etching. In one embodiment, both core and clad materials consist of thermoplastic resins with melt characteristics (MFI, Tg) similar enough to allow for extrusion through a 3D printing nozzle. Example core materials include PS, PMMA, SMMA, PVDF, Fluoropolymer, PETG, PC, COC, COP, PEN, ABS, ASA, polyester, thermoplastic elastomers, PVA, or other suitable thermoplastics. Example cladding materials include PS, PMMA, SMMA, PVDF, Fluoropolymer, PETG, PC, COC, COP, PEN, ABS, ASA, polyester, thermoplastic elastomers, PVA, or other suitable thermoplastics. The combination of the two materials is such that the core can be selectively etched using solvent, without etching away the cladding. The cross-sectional shape of the filament can be adjusted to match possible changes in nozzle shape (circular, triangular, square, hexagonal).

Analogous with the solid-core arrangements of FIGS. 2 and 3 discussed above, an air-core filament may be made in a multi-layer manner to include multiple concentric cylinders of material, with an inner air core and clad as described above or an etchable core/clad as described above. Additional layers may be used to achieve functions such as described above, i.e., (1) light absorption (e.g., EMA), to absorb unwanted light and improve optical performance, (2) providing physical/mechanical properties for strength or other purposes including to ease the 3D printing process (e.g., lower viscosity at nozzle temperature, increased adhesion) or to ease post-processing (e.g., lower viscosity at post-process fusion temperature, reducing Tg below other components in fiber to allow for gluing during fusion). An additional layer may also be used to alter/tune thermal conductivity or electrical conductivity, to reduce wear on the printing nozzle, or to provide etchability.

An air-core or etchable-core filament as above could have a core area made up of multiple core/clad combinations, such as described above with reference to FIGS. 2 and 3. Such arrangements may also employ additional functional structures (e.g., for light absorption, etc.) as described above. The air-core/etchable-core filament could be used as a feedstock to produce capillary devices designed for applications such as gas and liquid handling/analysis. In a capillary array format, this could include liquid/gas filters. A substrate for microchannel plates could be printed.

### 3. Method of Making Filament

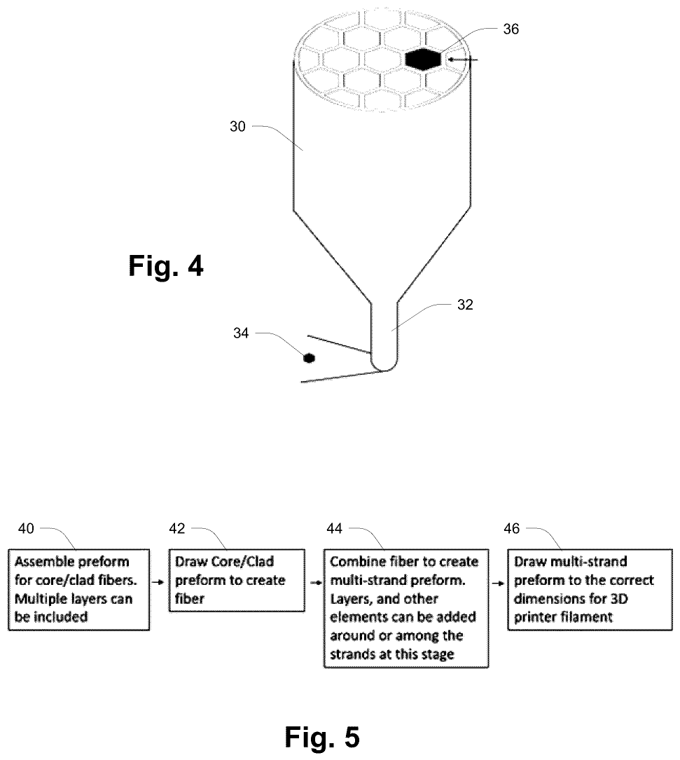

FIGS. 4 and 5 illustrate aspects of making a filament of the type described herein. FIG. 4 shows a multi-strand preform 30 being drawn into filament 32 for use in 3D printing, with the filament 32 having cross-sectional structure 34 matching (at reduced size) the cross-sectional structure 36 of the preform 30.

FIG. 5 is a flow diagram for creation of optical filament. At 40, respective preforms for individual core/clad fibers are assembled. Multiple layers may be included. At 42, these preforms are drawn to create the respective fibers. At 44, the fibers are combined to create a multi-strand preform. Additional functional layers and/or other elements (such as described above) may be added at this stage. At 46, the multi-strand preform is drawn to create the 3D printer filament. Referring again to FIG. 4, the preform 30 and filament 32 are examples of the results of steps 44 and 46 respectively.

As noted, additional components may be added into the preform to achieve the desired functions of the filament such as described above. These could be additional layers around the grouping of fibers (at 44) for light absorption or strength for example (such fibers being laid in amongst the transmitting fibers prior to drawing 46).

### II. 3D-Printed Device and Method of Making

Example devices that can be made by a 3D printing process using a filament as above include the following:
1. Faceplate—A faceplate can be created by translating the printer head in parallel lines that are tightly placed next to each other to minimize air gaps (see item G for more on air gaps). Parameters such as speed, extrusion width, infill percentage, fan cooling level, and temperature should be optimized here as well. The size of faceplate is predominantly dictated by the 3D printer build surface and height dimensions. Each subsequent z layer of the faceplate with repeat the same as the layer below, or it can be slightly offset to nest within the layer below. By making the length dimension of the faceplate longer and the cross-sectional area an imaging fiber can be produced.
2. Optical Taper—A tapered fiber optic component can be made using a 3D printing communication program that controls the placement of optical filament, nozzle extrusion width, infill percentage, flow rate, and speed to achieve the desired taper magnification and length of taper region. The fiber core size on one end of the taper is larger or smaller than the other end. This change in core diameter gives the optical part is tapered quality where an image is either shrunk or magnified, depending on the orientation the taper is used. This core size change through the length of the part is generally controlled by adjusting the extrusion width of the filament as it is extruded through the nozzle of the printer, or increasing the z-height within each layer.

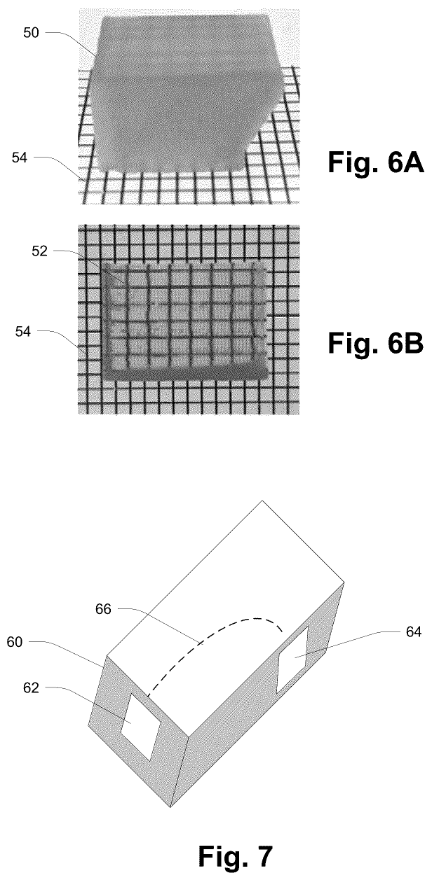

FIGS. 6A and 6b show an example taper 50, which may be formed by 3D printing successive layers. Size may be increased by a factor of 1.2× from beginning to end along the fiber path, for example (e.g., from bottom to top of taper 50 in FIG. 6A). FIG. 6B shows the effect of the taper 50 in use, providing a magnified image 52 of an underlying grid pattern 54.
3. Optical Inverter—An inverted optic can be created by utilizing a build plate (or printer head) that rotates in addition to moving in the x, y, and z directions. By rotating the build surface while printing, we can create a fiber structure that is rotated anywhere from 1 deg to 360 deg. The build surface would move towards and away from the nozzle while rotating to create the desired inverter geometry. This rotation and in-and-out motion would need to happen at the same time in order to create the inverter.
4. Bent fiber—A bent fiber optic is characterized by the fibers input plane being at an angle to the output plane at any angle from 1 deg to 360 deg. This geometry is achieved by bending the extruded filament around a programmed bent radius that where the fibers are continuous and not broken or shifted. Ensuring a non-sharp bend is important to maintain the transferred image quality from one plane to another. Fiber could also move up in z-height while bending, like a coil.

FIG. 7 is an example component 60 including a bent fiber within, which is not visible except for its input and output faces 62, 64. The bent fiber has a square cross section and exhibits a 90-degree bend from the input face 82 to the output face 64, as indicated by dotted line 66.

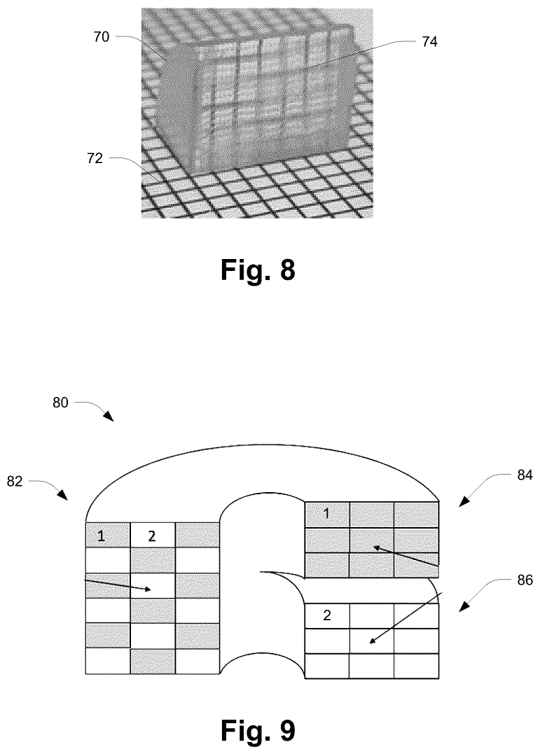

FIG. 8 illustrates another 3D printed part 70 having a 90 degree optical bend. An underlying grid pattern 72 in one plane becomes visible at 74 in an orthogonal plane.
5. Interleaved fiber-Interleaved fiber is a device in which there are a mixture of fibers on one end, which are separated into two or more different bundles on the other end. Two or more material architectures could be used by varying the input filament of two or more different extrusion nozzles. This device could be used to interleave illumination fiber with imaging fiber for endoscopy applications. It could also be used to split an image into two or more pieces.

FIG. 9 shows an Interleaved Fiber device 80 with a separation from one mixed bundle 82 into two separate bundles 84, 86. In this example the mixed bundle 82 has fibers of respective distinct types or structures (shown as 1 and 2), which are separated out in the respective bundles 84, 86 (i.e., type 1 fibers in bundle 84, type 2 fibers in bundle 86).
6. Flexible Fiber Imaging Bundle-A flexible fiber imaging bundle can be produced in a similar fashion to a faceplate but requires an outer clad material that is soluble to a select solvent while the remainder of the fiber is a material or combination of materials insoluble to the same select solvent. The printing process will be no different than creating a faceplate. Upon print completion the sections of the item where etching is desired will then need to be selectively submerged in the solvent that is intended to etch away fiber clad material while leaving the remainder of the fiber material undisturbed. This can allow for a solid imaging surfaces on either end of the bundle, with flexible fibers in between.
An alternative method for making this device would be to print two solid end sections where the fibers are close together and connected, with a print style in between which keeps the individual extruded optical filament elements from being connected. This leaves two solid fiber optic faceplates connected with loose/flexible filament.

Items 1 through 6 above may also require a post processing fuse step. This fuse step utilizes pressure, temperature, and time to push out any remaining air gaps remain after printing. This step may not always be needed, as it may depend on the printer settings used to create the device. Air gaps can be minimized during the printing process by adjusting infill percentage and extrusion width parameters to fully fill out interstitial gaps between the layers of extruded filament.

Items 1 through 6 above may use capillary (hollow) filament rather than solid filament. Examples: capillary plate, capillary taper, capillary inverter, bent capillary array, interleaved capillary plate/fiber, flexible capillary bundle. For capillary devices made using filament, both a fusion process to remove unwanted air gaps, as well as an etch process to dissolve the core area and replace with air may be required. For an air-core filament, various techniques may be required to retain the desired air core structure while eliminating unwanted air gaps between 3D print passes. By using a filament with two cladding layers around an air hole, a fusion temperature can be selected which is higher than the Tg of the outer clad, but lower than the Tg of the inner clad. By fusing under pressure this will allow the removal of unwanted air gaps, while retaining the capillary structure. In addition, by closing the ends of the continuous extruded capillary material, or introducing air pressure at the end, unwanted air gaps could be removed by applying heat and restricting the volume, retaining the desired capillary structure. Also, single capillary tubes can be printed onto another device, where the exact placement of the individual tubes can be controlled exactly by the movement of the printer head.

### Other Devices

### 3D Printed Focused Optical Fiber Array-Both Scintillating and Non-Scintillating.

Radiation sources normally have some beam divergence (described further below), which can lead to reduced resolution in a detector. A 3D printed faceplate (which may be made from material that has contained within it a scintillating material) may be made in a geometry that counteracts the beam divergence of the radiation or light source. This could be a fanout in three dimensions or just two. The 3D filaments can take many forms, such as nanoguide, single core, multicore filaments, graded index, etc. Two component/filament printers can be used to further isolate channels from each other if desired. A grid component can be composed of material that is designed to either absorb (black), reflect (white) or bounce through a refractive index change, or possibly composed of a random combination of two or more polymers of different refractive indices to provide Transverse Andersen Localized waveguiding to prevent light passage through channel walls, etc. Such a structure may look like a grid from above and fan out to compensate for beam divergence.

One system-level problem is that source radiation normally comes from a spot located some distance away. Such source radiation can be photons of any energy, neutron, elections, beta particles, and others. The radiation beam has divergence as it travels from the spot to the detector. This causes image blur since the radiation can travel different depth in the material before interacting as shown in first figure. Another problem is that when radiation interacts with matter, the light generated by a scintillation event is generally omnidirectional. The resulting outputs of that interaction can be in any direction as long as total energy and momentum are conserved. This can also blur the image, thereby limiting the thickness of scintillating material that can be used before the image is too degraded.

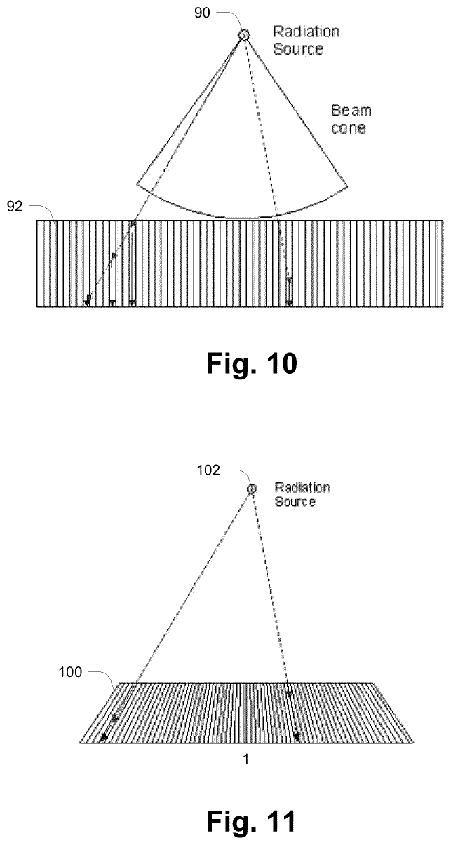

FIG. 10 shows an example of a known arrangement in which radiation from a point source 90 enters a scintillating faceplate 92 having an array of scintillating channels. Vertical lines within the faceplate indicate scintillation events. With this configuration, radiation causes events in different channels, resulting in blur.

FIG. 11 shows an approach to address the above problems using faceplate formed by 3D printing as described herein. In the faceplate 100, the channels are sloped to align with the local path of the radiation from the source 102. Scintillation light travels away in the same direction as incident light, reducing blur in a detected image.

Generally, a 3D printed faceplate may be made of a material that has contained within it a scintillating material, along with a light blocking or reflective material in a geometry that minimizes crosstalk. The geometry may also be such that the beam divergence is compensated for. The scintillating material may be a material such as pure scintillator or a random combination of two or more polymers, where one or more are scintillating, of different refractive indices to provide Transverse Andersen Localized waveguiding.

In another aspect, a multi-filament printer (e.g., two-filament) printer may be used to form optical devices. For example, both a grid (light blocking) material and active scintillating material can be printed together at the same time. The scintillating material may be a single element or be a SNG material to further help the light guiding. A multi-section filament such as described above with reference to FIG. 2 may be used, with the core being a single scintillating element, multiple core/clad scintillating fibers, or an SNG material. In addition, a layer of EMA material may surround either each core or each filament section to reduce crosstalk/block light.

### 3D-Printed Large Structure

Another system-level problem in display applications is to move light from a flat plane to a curved surface. Flat to curved parts can be used to build up full or partial curved surfaces where all light is directed towards the center of the curved shape. A typical application would be a spherical simulator.

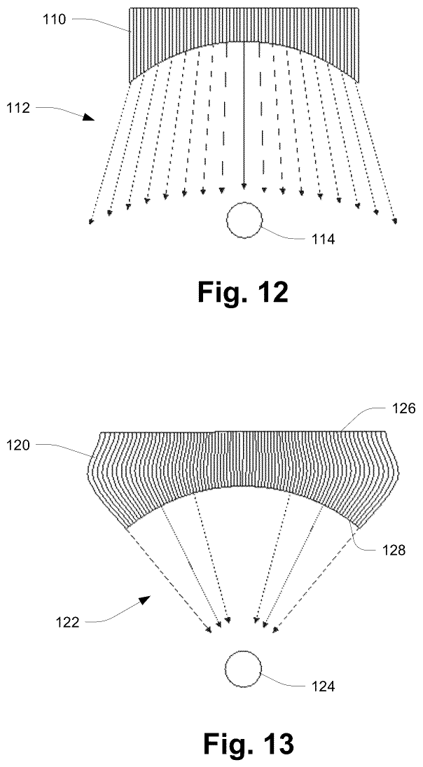

FIG. 12 illustrates a potential problem when a set of conventionally formed optical fibers are used. A curve is cut into a part 110 having straight optical fibers. As illustrated, the light 112 exiting the curved face is directed away from the focal point 114.

FIG. 13 shows an approach to address the above problems with a faceplate formed by 3D printing as described herein. In the faceplate 120, the channels are bent such that the light 122 is directed towards the focal point 124. The channels may be perpendicular to the flat face 126 to allow for better coupling with a separate display (not shown). The channels may also be perpendicular to the curved face 128 to facilitate directing the light towards the focal point 124.

### Method of Making Optical Device Using Filament

Filament can be extruded through a 3D printer in many different ways and with many different pieces of equipment. Different nozzle types such as square or hexagonal nozzles (or possibly any polygon) can be used to extrude specifically sized layer lines. For example, the square nozzle shape can help reduce the prevalence of air gaps within the 3D printed part by filling the corners of each layer line with optical filament material. Internal nozzle architecture, in terms of input size, output size, and slope/wall between, is preferably at a correct angle to allow for laminar flow, to prevent mixing or disruption of the optical fiber filament as it passes through the nozzle.

A 3D printer may be programmed with custom created gcode to allow for non-standard control of the printer. Generally, slicer programs are used to generate a gcode text file that tells the 3D printer what actions to perform to create the desired part. Printing optical components is different than creating opaque, structured 3D printed parts, and manipulation is typically required through manual programming to influence the printing parameters that lead to better optical quality parts. Such custom gcode may be written to make the nozzle move in a specific tool path to achieve the correct optical structure. This tool path lays filament down in parallel lines, without crossing over already placed lines, and starting and ending at the same point at each layer. Additional layers (in z direction) may need to be either directly placed on top of lower layer lines or nested in between the lower layer lines to minimize air gaps. Control of the nozzle height (z) is also adjusted within a given layer (where, traditionally, the nozzle is only moved in height for each new layer) to create tapered features.

Parameters such as extrusion width are crucial to understand and control when making optical parts on a 3D printer. Varying the extrusion width allows for core size changes that allow taper components to be created. Smaller cores on one end of the taper and larger cores on the other end of the taper. Nozzle size dictates the min and max that extrusion width can be altered for a given print. For capillary filament with an air core, pressure can be applied to the filament end to retain the air hole or vary the air ratio through the extrusion process.

While various embodiments of the invention have been particularly shown and described, it will be understood by those skilled in the art that various changes in form and details may be made therein without departing from the scope of the invention as defined by the appended claims.

What is claimed is:

1. A filament for use as a feedstock in three-dimensional printing of an optical device, the filament having a strand-like structure for continuous feeding into a printing nozzle of a three-dimensional printer, the strand-like structure including one or more of elongated side-by-side core/cladding sections each having an optically transmissive inner core surrounded by a lower-index optically transmissive outer cladding for corresponding light guiding in the optical device.

2. The filament of claim 1, including one or more concentric additional layers of material surrounding the one or more core/cladding sections, the additional layers providing one or more of (1) unwanted light absorption, (2) physical properties for improved 3D printing using the filament, (3) physical properties for improving post-processing of the optical device after 3D printing, (4) added strength, (5) altered thermal and/or electrical conductivity, (6) etchability.

3. The filament of claim 2, having multiple of the core/cladding sections forming a core area surrounded by the additional layers.

4. The filament of claim 1, wherein the inner core of one or more of the core/cladding sections includes a scintillating material.

5. The filament of claim 1, wherein the inner core of one or more of the core/cladding sections includes a random combination of two or more materials of differing refractive indices to provide Transverse Andersen Localized waveguiding.

6. The filament of claim 5, wherein one or more of the materials is a scintillating material.

7. The filament of claim 1, wherein additional structures are disposed among the core/clad structures to provide one or more of (1) unwanted light absorption, (2) added strength, (3) altered thermal and/or electrical conductivity, (4) etchability.

8. A filament for use as a feedstock in three-dimensional printing of a capillary device, the filament having a strand-like structure for continuous feeding into a printing nozzle of a three-dimensional printer, the strand-like structure including one or more of elongated side-by-side air/clad sections each having an open air core surrounded by an outer cladding.

9. A filament for use as a feedstock in three-dimensional printing of a capillary device, the filament having a strand-like structure for continuous feeding into a printing nozzle of a three-dimensional printer, the strand-like structure including one or more of elongated side-by-side core/cladding sections each having an inner core surrounded by an outer cladding, wherein the inner core has a sufficiently different chemical solubility to allow for selective etching.

10. A method of making a filament for use in three-dimensional printing of optical devices, comprising:
assembling first preforms for respective individual core/clad fibers;
drawing the first preforms to form the respective core-clad fibers;
combining the core-clad fibers to create a multi-strand second preform; and
drawing the multi-strand second preform to create the filament.

11. A method of making an optical device, comprising:
performing three-dimensional printing in a predetermined pattern using a core/clad filament as a feedstock, the filament having a strand-like structure for continuous feeding into a printing nozzle of a three-dimensional printer used in the three-dimensional printer, the strand-like structure including one or more of elongated side-by-side core/cladding sections each having an optically transmissive inner core surrounded by a lower-index optically transmissive outer cladding for corresponding light guiding in the optical device.

12. An optical device produced by the method of claim 11.

13. A filament for use as a feedstock in three-dimensional printing of an optical device, the filament having a strand-like structure for continuous feeding into a printing nozzle of a three-dimensional printer, the strand-like structure including one or more of elongated side-by-side core sections each having an optically transmissive inner core for corresponding light guiding in the optical device, wherein the inner core of one or more of the core sections includes a random combination of two or more materials of differing refractive indices to provide Transverse Andersen Localized waveguiding.
